(19) United States
(12) Patent Application Publication
(10) Pub. No.: US 2012/0290125 A1
(43) Pub. Date: Nov. 15, 2012

(54) METHOD OF TRANSFERRING CONTAINERS AND STORAGE SYSTEM FOR CONTAINERS

(75) Inventor: Arie Perry, Hod Hasharon (IL)

(73) Assignee: ISRAEL AEROSPACE INDUSTRIES LTD., Lod (IL)

(21) Appl. No.: 13/575,198

(22) PCT Filed: Feb. 28, 2011
(86) PCT No.: PCT/IL11/00197

§ 371 Date: Jul. 25, 2012

(30) Foreign Application Priority Data
Feb. 28, 2010 (IL) 204199

(51) Int. Cl. B65G 1/04; G06F 7/00; B65G 63/00

(52) U.S. Cl. 700/218; 414/807; 414/139.9

(57) ABSTRACT

A method of transferring a plurality of containers to storage is provided, the method comprises providing at least one multi-level structure (12) with an elevator (22) configured to receive and transport one or more containers thereupon and being configured to ascend and descend to a predetermined level (18a), each of the levels (18a) comprising a plurality of bays (24) being sized to receive and store therein one of the containers; providing a plurality of unmanned autonomous guided vehicles (AGV) configured to perform front/back and sideways movements and to receive a container thereupon; receiving each of the containers on a receiving AGV (rAGV) of the AGVs; and positioning the rAGV with the container received thereby in a target bay (24) on a target level (18a) of the structure (12).

### FIELD OF THE INVENTION

This invention relates to methods of transferring shipping containers, and in particular to methods of storing shipping containers from marine vessels and receiving them from storage for distribution to vehicles for delivery.

### BACKGROUND OF THE INVENTION

Shipping freight via containers remains a cost effective way transport goods globally. Typically, many such containers are transported on a marine vessel and unloaded at a port. The containers are then stored at or near the port, until trucks arrive to transport each container to its intended location.

Between the time the containers are unloaded from the marine vessel and transported by the truck, the containers are stored. The containers are typically stacked. The height of each stacks is limited by the weights of the containers and their strength, although usually they do not exceed six containers. Retrieval of each container involves identifying the location of a desired container among the stacks, and, if necessary, relocating containers which are above it in order to retrieve the desired container for placement on a truck.

### SUMMARY OF THE INVENTION

According to one aspect of the presently disclosed subject matter, there is provided a method of transferring a plurality of containers to storage, the method comprising:
providing at least one multi-level structure with an elevator configured to receive and transport one or more containers thereupon and being configured to ascend and descend to a predetermined level, each of the levels comprising a plurality of bays being sized to receive and store therein one of the containers;
providing a plurality of unmanned autonomous guided vehicles (AGV) configured to perform front/back and sideways movements and to receive a container thereupon;
receiving each of the containers on a receiving AGV (rAGV) of the AGVs; and
positioning the rAGV with the container received thereby in a target bay on a target level of the structure.

The structure may further comprises a balcony, the receiving of containers taking place on the balcony.

AGVs may be stored on each level of the structure. Prior to the receiving, the target bay may be designated, the rAGV being selected from an AGV stored on the target level.

Subsequent the positioning, the rAGV may exit the target bay and leave its associated container (i.e., the container it is carrying) there.

Each of the plurality of bays may comprise an arrangement for supporting a container.

Each of the AGVs may be configured to alter its height between a raised height and a lowered height, with the arrangement comprising a plurality of supports, each having a height which is higher than the lowered height of the AGVs, and lower than the raised height of the AGVs.

The arrangement may comprise a plurality of supports, each configured for having its height adjusted between a raised height and a lowered height, the raised height of each support being higher than the height of the AGVs, and the lowered height of each support being lower than the height of the AGVs.

Each of the AGVs may be configured to alter its height between a raised height and a lowered height, with the method further comprising providing a plurality of movable supports configured for supporting a container, each of the movable supports having a height which is higher than the lowered height of the AGVs, and lower than the raised height of the AGVs.

The method may further comprise providing a control system configured to issue one or more commands to each of the AGVs. Each of the AGVs may be configured to perform a series of movements in response to the commands.

The control system may be configured to receive information relating to the identity of each of the containers and to correlate the identity to the rAGV on which it is received.

The method may further comprise, prior to completion of the transferring, displacing an obstructing container initially obstructing the path of the rAGV. The displacing may comprise directing the obstructing container to move to an unoccupied bay. The displacing may comprise directing the obstructing container to move from the level in which it is stored. The elevator may be sized so as to receive two adjacent AGVs, each carrying a container thereupon, and wherein the displacing comprises directing the obstructing container to move to the elevator. The method may further comprise, subsequent to the positioning of the rAGV in a target bay, directing the obstructing container to move to its previous location.

The containers may be received from a marine vessel. The containers may be transferred from the marine vessel to the rAGV using a crane.

At least some of the containers may be transferred from the marine vessel to an intermediate vehicle, and from the intermediate vehicle to the rAGV.

According to another aspect of the presently disclosed subject matter, there is provided a method of transferring a plurality of containers from storage, the method comprising:
providing at least one multi-level structure with an elevator configured to receive and transport one or more containers thereupon and being configured to ascend and descend to a predetermined level, each of the levels comprising a plurality of bays being sized to receive and store therein one of the containers, at least one of the levels constituting a transfer level, at least some of the bays having containers stored therein;
providing a plurality of unmanned autonomous guided vehicles (AGV), each containing configured to perform front/back and sideways movements and to receive a container thereupon;
identifying a container-to-be-transferred;
directing a designated AGV to retrieve the container-to-be-transferred from the bay and move it toward a vehicle; and
transferring the container-to-be-transferred to the vehicle.

The AGVs may be stored on each level of the structure. The designated AGV may be selected from an AGV stored on the same level as the container.

Each of the plurality of bays may comprise an arrangement for supporting a container.

Each of the AGVs may be configured to alter its height between a raised height and a lowered height, with the arrangement comprising a plurality of supports, each having a height which is higher than the lowered height of the AGVs, and lower than the raised height of the AGVs.

The arrangement may comprise a plurality of supports, each configured for having its height adjusted between a raised height and a lowered height, the raised height of each support being higher than the height of the AGVs, and the lowered height of each support being lower than the height of the AGVs.

Each of the AGVs may be configured to alter its height between a raised height and a lowered height, with the method further comprising providing a plurality of movable supports configured for supporting a container, each of the movable supports having a height which is higher than the lowered height of the AGVs, and lower than the raised height of the AGVs.

The method may further comprise providing a control system configured to issue one or more commands to the AGVs.

The AGVs may be configured to perform a series of movements in response to the commands.

The method may further comprise, prior to completion of the transferring, displacing an obstructing container initially obstructing the path of the designated AGV.

The displacing comprises directing the obstructing container to an unoccupied bay. The to displacing may comprise directing the obstructing container from the level in which it is stored. The elevator may be sized to as to receive two adjacent AGVs, each carrying a container thereupon, with the displacing comprising directing the obstructing container to move to the elevator. The method may further comprise, subsequent to the directing the designated AGV to move from its bay, directing the obstructing container to move to its previous location.

The vehicle may be a truck a train. The structure may comprise a hoist configured to transfer the container to the vehicle. The vehicle may be a marine vessel.

According to a further aspect of the presently disclosed subject matter, there is provided a method of transferring a plurality of container, comprising:
transferring the containers to storage as described above; and
transferring the containers from storage as described above.

According to a still further aspect of the presently disclosed subject matter, there is provided a storage system, comprising:
at least one multi-level structure with an elevator configured to receive and transport one or more containers thereupon and being configured to ascend and descend to a predetermined level, each of the levels comprising a plurality of bays being sized to receive and store therein one of the containers;
a plurality of unmanned autonomous guided vehicles (AGV) configured to perform front/back and sideways movements and to receive a container thereupon; and
a control system configured to direct operation of the AGVs to receive containers, bring containers to a target bay for storage, and retrieve stored containers.

The structure may further comprise a balcony configured for supporting an AGV with a container thereupon, wherein direct access is provided for an AGV with a container thereupon between at least one level of the structure and the balcony.

The structure may be provided adjacent a body of water, the balcony being on a side of the structure facing the body of water.

The elevator may be configured to receive and transport two containers thereupon.

Each of the plurality of bays may comprise an arrangement for supporting a container.

Each of the AGVs may be configured to alter its height between a raised height and a lowered height, with the arrangement comprising a plurality of supports, each having a height which is higher than the lowered height of the AGVs, and lower than the raised height of the AGVs.

The arrangement may comprise a plurality of supports, each configured for having its height adjusted between a raised height and a lowered height, the raised height of each support being higher than the height of the AGVs, and the lowered height of each support being lower than the height of the AGVs.

Each of the AGVs may be configured to alter its height between a raised height and a lowered height, with the method further comprising providing a plurality of movable supports configured for supporting a container, each of the movable supports having a height which is higher than the lowered height of the AGVs, and lower than the raised height of the AGVs.

AGVs may be stored on each level of the structure.

### BRIEF DESCRIPTION OF THE DRAWINGS

In order to understand the invention and to see how it may be carried out in practice, an embodiment/embodiments will now be described, by way of a non-limiting example/examples only, with reference to the accompanying drawings, in which:

FIG. 1 is a schematic illustrated of a storage system according to the presently disclosed subject matter;

FIG. 2 is a perspective view of a multi-level structure of the storage system illustrated in FIG. 1;

FIGS. 3A through 3D illustrate examples of schematic floor plans of one level of the structure illustrated in FIG. 2;

FIG. 4A is another example of a schematic floor plan of one level of the structure illustrated in FIG. 2;

FIG. 4B is s schematic side view of a structure with a floor as illustrated in FIG. 4A;

FIG. 5 is a schematic perspective view of an autonomous guided vehicle (AGV) of the storage system illustrated in FIG. 1;

FIG. 6 is a schematic perspective view of an example of a wheel of the AGV illustrated in FIG. 4;

FIG. 7 is a schematic illustration of a control system of the storage system illustrated in FIG. 1;

FIGS. 8 and 9 illustrate arrangements for supporting a shipping container above the floor;

FIG. 10 schematically illustrates a method of unloading and storage using the storage system illustrated in FIG. 1; and

FIG. 11 schematically illustrates a method of retrieval using the storage system illustrated in FIG. 1.

### DETAILED DESCRIPTION OF EMBODIMENTS

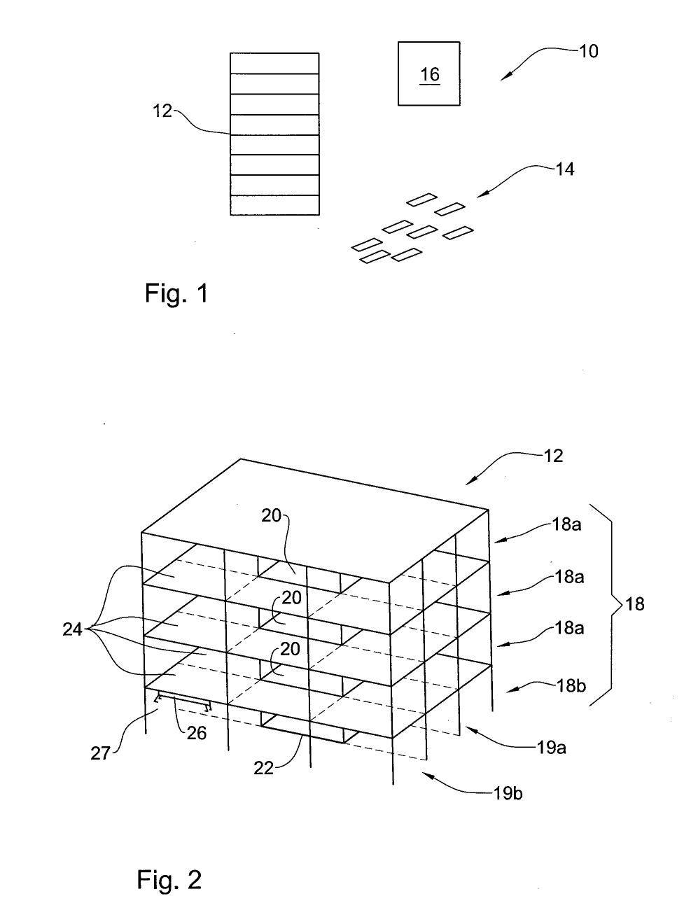

As illustrated in FIG. 1, there is provided a storage system, which is generally designated by 10. The storage system comprises a multi-level structure 12, a plurality of autonomous guided vehicles (AGVs) 14, and a control system 16. The structure 12 is typically constructed in the vicinity of a marine shipping dock, for example in a shipping yard.

As mentioned above and illustrated in FIG. 2, the structure 12 comprises a plurality of levels 18, and an elevator shaft 20 spanning therebetween. The shaft may be constituted by vertically aligned gaps in each level. An elevator 22, which may be open (i.e., comprising a platform configured to be moved vertically within the shaft 20), and may also comprise moveable safety rails (not illustrated) configured to prevent an AGV 14 thereupon to fall off, is provided to move within the shaft. (The elevator 22 is illustrated on the bottom floor of the structure in FIG. 2.)

It will be appreciated that the structure 12 illustrated in FIG. 2 is for explanatory purposes only, and, in practice, a structure with more or fewer stories than shown may be provided.

The shaft 20 and elevator 22 are sized such that an AGV 14 with a standard shipping container thereupon can be transported on the elevator to any level 18 of the structure 12. According to a modification, the structure 12 may comprise more than one elevator 22, for example two.

According to another modification, the shaft 20 and elevator 22 may be sized such that more than one, for example two, AGV 14, each with a standard shipping container thereupon, can be transported on the elevator to any level 18 of the structure 12. According to this modification, the elevator 22 is sized such that two AGVs 14, each carrying shipping container, can fit thereon when arranged adjacent one another (i.e., the elevator is the size of two adjacent bays 24).

The standard shipping container size used to determine the size of the shaft 20 and elevator 22 may be, for example, a 20-foot container (having dimensions of 2.44 m h×2.44 m w×6.1 m l), a 40-foot container (having dimensions of 2.44 m h×2.44 m w×12.19 m l), a “high-cube” container (having similar dimensions to 20- and 40-foot containers but having a larger height, for example 2.9 m or 3.2 m), or any type of container manufactured to ISO specifications.

The levels 18 of structure which are used for storage (hereafter, “storage levels” and designated 18a; i.e., not including those in which containers are transferred from the AGVs 14 to trucks, as will be described below; herein the presently disclosed subject matter, when reference is made to different types of levels, the reference number 18 will be used to refer to them collectively) are generally free of conveyances which are designed to transfer containers. The only means of transferring containers on these levels are the AGVs 14.

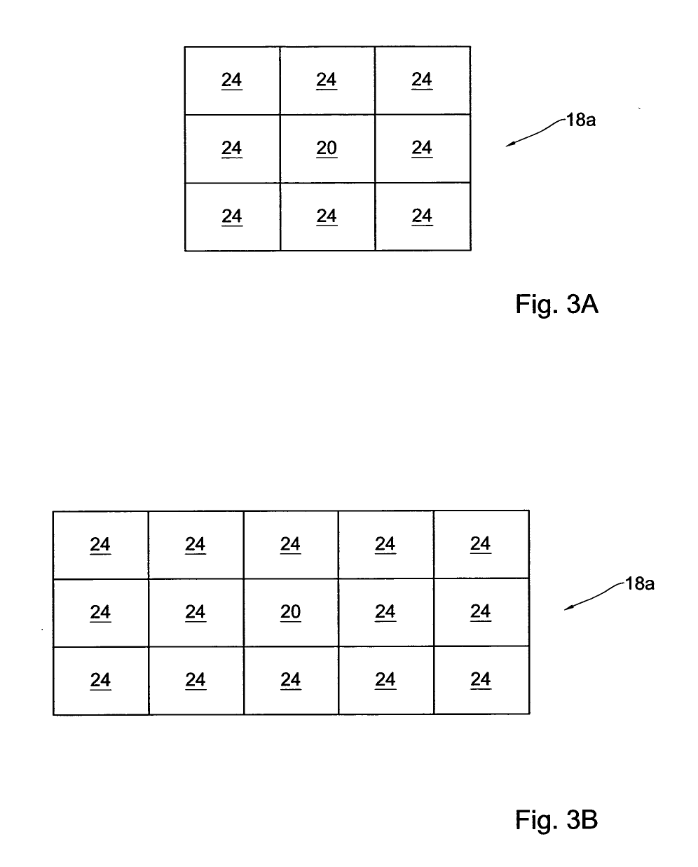

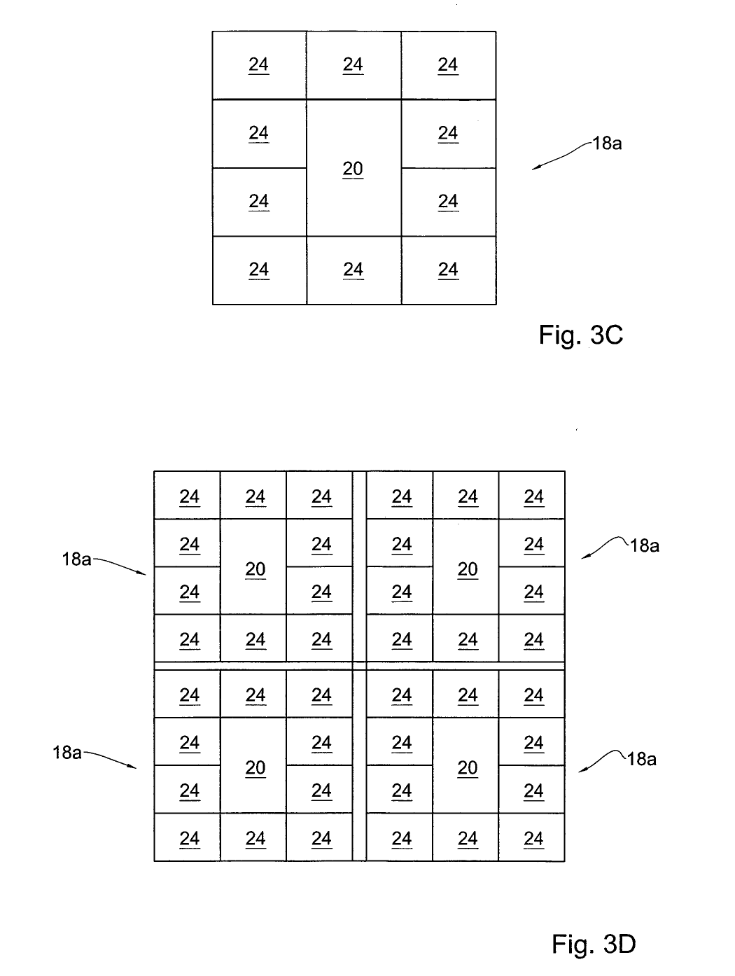

As illustrated in FIGS. 3A through 3C, each storage level 18a comprises a plurality of bays 24 (indicated in broken lines in FIG. 2) laid out in a substantially rectangular array (i.e., a grid pattern), with the elevator shaft 20 passing in the middle thereof and occupying one of the spaces of the array. According to the design illustrated in FIG. 3A, the rectangular array is a “three by three” array (i.e., three rows and three columns), with eight bays 24 surrounding the elevator shaft 20.

According to the design illustrated in FIG. 3B, the rectangular array is a “three by five” array (i.e., three rows and five columns), which is similar to the “three by three” array illustrated in FIG. 3A, with the addition of a column of bays 24 on each side thereof As can be seen in the figure, the elevator shaft 20 is located in the center of the array.

According to the design illustrated in FIG. 3C, the rectangular array is a “four by three” array (i.e., four rows and three columns), which is similar to the “three by three” array illustrated in FIG. 3A, with the substitution of an elevator 22 which can accommodate two AGVs 14 at the same time (as described above), and thus the addition of a row of bays 24. As can be seen in the figure, the elevator shaft 20 is located in the center of the array, and shares either a side or a corner with all of the bays 24 on the floor 18.

According to any design of the storage levels 18a, several structures 12 may be arranged adjacent one another, for example as illustrated in FIG. 3D. According to this arrangement, the levels 18 of adjacent buildings (in the example illustrated in FIG. 3D, the storage levels 18a of the structure are provided according to the design illustrated in FIG. 3C; levels of different structures are separated by double lines for clarity) may be used together, and related to, for example from a storage and/or an operational point of view, as a single large level. It will be appreciated that herein the specification and claims, a reference to a structure applies, mutatis mutandis, to several structures arranged adjacent one another as illustrated in FIG. 3D.

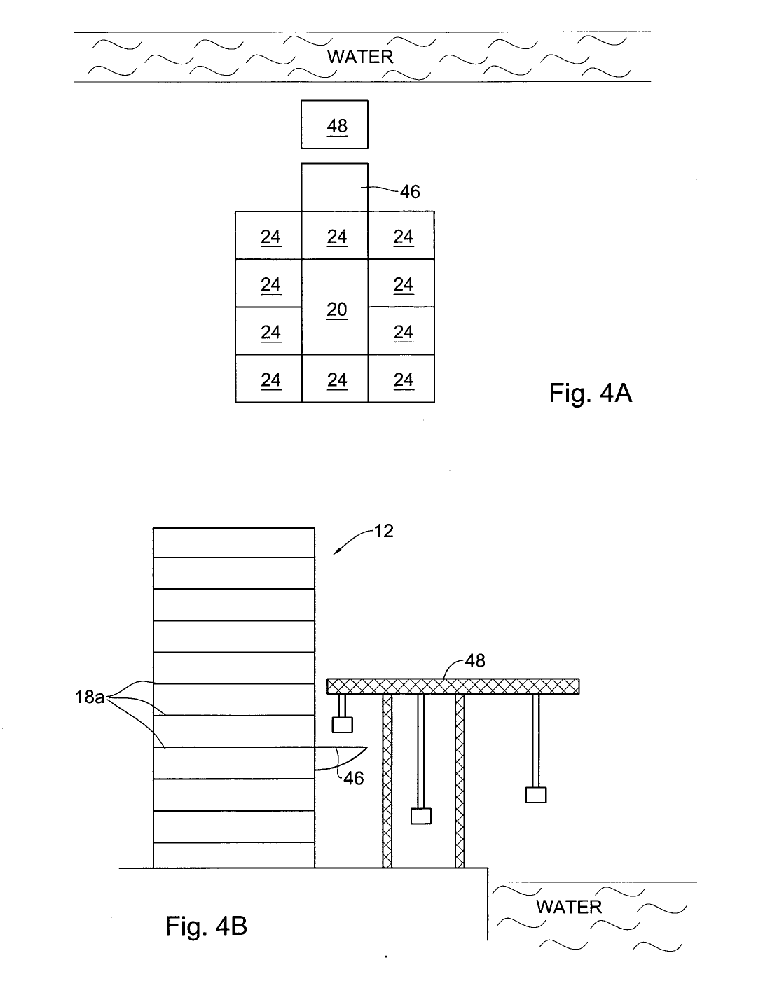

As illustrated in FIGS. 4A and 4B, at least one of the storage levels 18a may be provided with a balcony 46. The balcony 46 is provided facing the water, and a transfer device 48, for example a bridge crane, configured to transfer containers from a marine vessel may be provided between the balcony and the water.

As seen in FIG. 4B, the transfer device 48 may be configured so as to selectively transfer a container either to a balcony 46 of the structure 12, or to a vehicle (such as a train or a truck) separate from the structure.

It will be appreciated that any suitable configuration may be provided without deviating from the scope of the presently disclosed subject matter. As will become clear below, there are certain advantages to locating the elevator shaft 20 to be as close to the center position of its array as possible. However, such a disposition thereof is not strictly necessary.

Reverting to FIG. 2, a transfer level 18b is provided, typically as the ground floor level of the structure 12. It is on this level that containers are transferred from the AGVs 14 to trucks (not illustrated) or any other transport means which takes the containers from storage within the structure 12 toward their eventual destinations. The transfer level 18b may be functionally divided into an AGV area 19a, wherein AGVs 14 arrive after being loaded with a container from a marine vessel, and a truck area 19b, wherein trucks receive containers from their storage location within the structure 12.

According to a modification, the AGV area 19a and the truck area 19b may be on separate levels. According to another modification, a single structure 12 may comprise more than one AGV area 19a and/or more than one truck area 19b.

As such, the structure 12 is provided, on the transfer level 18b thereof, means configured to transfer a container from an ACV to a truck, e.g., to a flatbed trailer designed to receive a container. The means may comprise a hoist 26 configured to lift a container from an AGV 14, and maintain it in a raised position until a truck is positioned thereunder, at which point the hoist lowers the container onto the truck. The hoist 26 may comprise a gripping arrangement 27 configured to hold the container, connected via cables to a system of winches which may be controlled to raise and lower the container. It may also contain means to facilitate lateral movement of the container when held by the gripping arrangement 27 in a raised position.

It will be appreciated that although the structure 12 is described herein as comprising a single hoist 26, any number of hoists may be provided. This facilitates simultaneous loading of containers onto more than one truck.

This arrangement described above in connection with the transfer level 18b allows quick transfer of a container recalled from storage onto a truck. It may also facilitate, if necessary, transfer of a container, which was retrieved from the marine vessel and not stored within the structure 12 or any other storage area, onto a truck.

It will be appreciated that while the levels 18 of the structure 12 as described herein and illustrated in the accompanying drawings are above ground, the structure may be provided with one or more levels below ground. According to a modification, all of the levels 18, with the optional exception of the transfer level 18b, may be provided below ground.

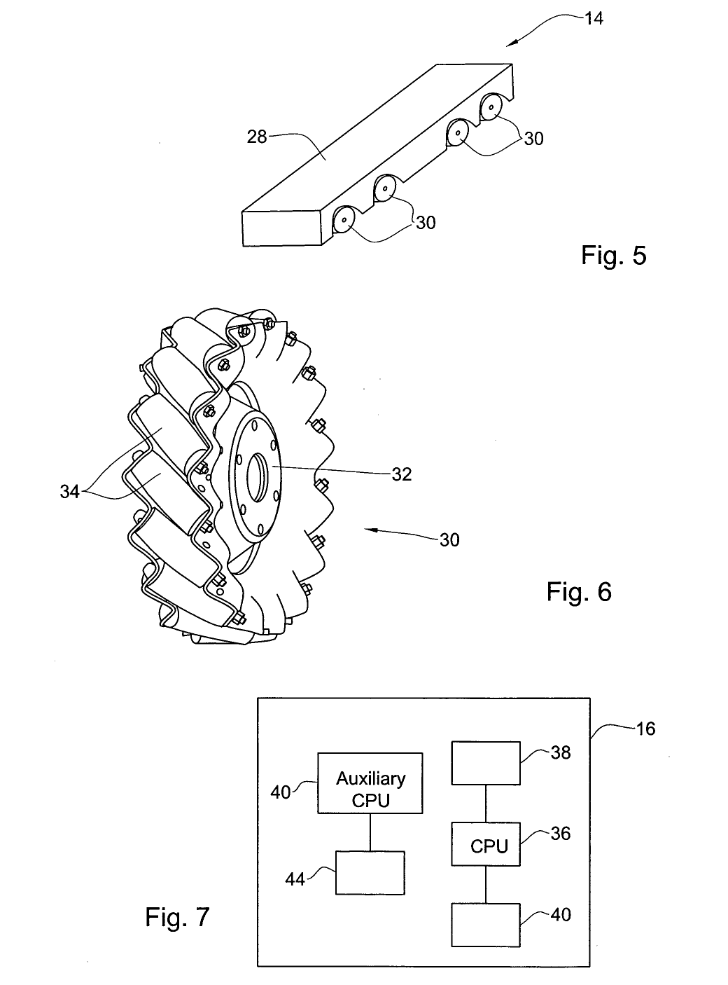

As illustrated in FIG. 5, each AGV 14 comprises a flat, level body 28 (i.e., a “flatbed”) and a plurality of wheels 30. The body is sized so as to receive thereon and support a standard shipping container. The vehicle may comprise four, six, eight, or any other appropriate number of wheels. It may be configured to move in any direction, i.e., forward, backward, sideways, diagonally, etc., without undergoing any rotation. In addition, it may be configured to pivot about an axis.

As illustrated in FIG. 6, each wheel 30 may be provided as a Mecanum wheel (sometimes called a “Swedish wheel”). As such, it may comprise a mail wheel 32 with a series of rollers 34 attached along its circumference with an axis of rotation at 45° to the plane of the wheel in a plane parallel to the axis of rotation of the wheel. This arrangement facilitates moving of the AGV 14 forward and backward (such as is made possible by conventional wheels), while allowing sideways and diagonal movement, as well as pivoting about different axes, by appropriate spinning of the different wheels, as is known in the art.

Each of the bays 24 may be provided with an arrangement for supporting a shipping container in a position raised above the floor, while providing access to an AGV 14 therebeneath. In addition, either the AGV 14 or the arrangement for supporting a container (or both together) may be configured to transfer the container from the arrangement to the AGV, and vice versa.

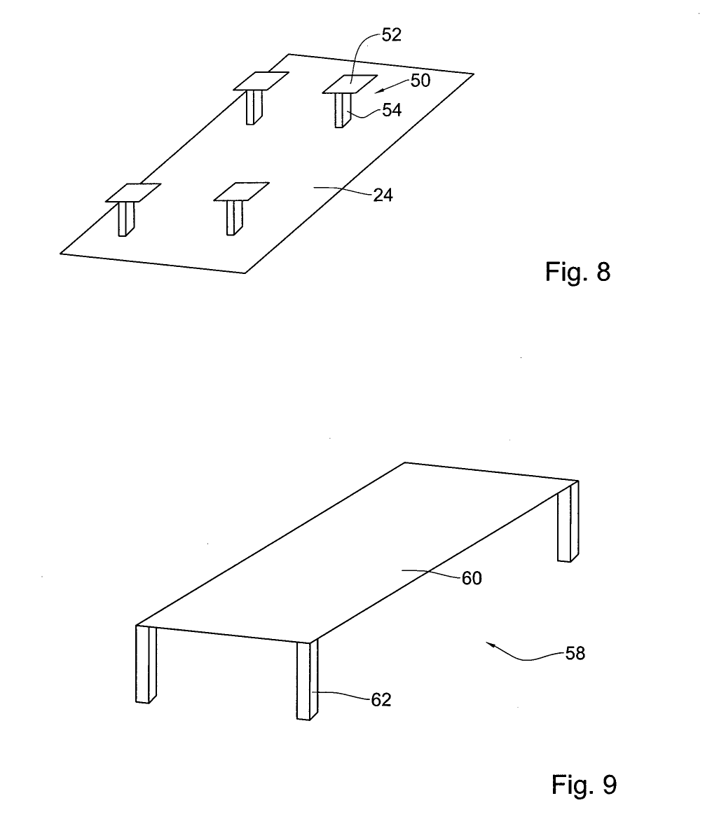

According to one modification, which is illustrated in FIG. 8, the arrangement for supporting a shipping container comprises a plurality, for example four, of raised support 50 rigidly connected to the floor of each bay 24. Each raised support 50 comprises an upper platform 52 supported by a leg 54. (It will be appreciated that the raised support 50 may be provided without an upper platform 52, in which case the upper platform referred to in the following description may refer to the upper surface of the leg 54.)

The supports 50 are arranged such that all the upper platforms 52 thereof can together receive and support thereon a standard shipping container. The space between adjacent supports 50 is sufficient to allow passage therethrough of and AGV 14, as will be described below. In order to facilitate this, legs 54 may be provided only at each of the corners of the support 50, so that an AGV 14 may access the area below the platform 52 from any side of the support.

According to another modification, which is illustrated in FIG. 9, the storage system 10 is provided with a plurality of movable supports 58. Each of the moveable supports 58 comprises an upper platform 60 supported by four legs 62. The height of the legs 62 is such that an AGV 14 may enter the area below the upper platform 60. Typically, a small clearance, for example on the order of a few centimeters, is allowed between bottom edges of the upper platform 60 and the top of the AGV 14.

According to either of the modifications illustrated in FIGS. 8 and 9, the AGV 14 is provided with a mechanism configured to selectively raise and/or lower the body 28 thereof, thereby changing its height. In addition, it is sized so as to be able to fit between legs 54, 62 of the respective support 50, 58.

According to the modification illustrated in FIG. 8, an AGV 14 in its raised position carries a container to the bay, and positions itself such that the container is above the platforms 52. It then lowers itself, such that the container is supported by the supports 50. Subsequently, the AGV 14 may leave the bay. In order to retrieve the container from the bay 24, the AGV performs a reverse sequence of actions.

According to the modification illustrated in FIG. 9, when an AGV 14 is ready to receive a container, it positions itself under an empty support 58, raises itself (thus raising the support off of the floor), and carries the support to an area in which it receives the container. Once the container is received thereon (i.e., on the support 58 which is on the AGV 14) it proceeds to a selected bay 24. The AGV 14 lowers itself, thus resting the legs 62 of the support 58 on the floor. Subsequently, the AGV 14 may leave the bay 24, leaving the support 58 with the container thereupon. In order to retrieve the container from the bay 24, the AGV performs a reverse sequence of actions.

As an alternative to the modification illustrated in and described with reference to FIG. 8, the supports 50 may be configured to be raised and lowered. They may be lowered such that the upper surface thereof is flush with the floor (or close enough to the floor such that an AGV 14 may drive over it without its movement being substantially affected thereby), or enough such that a container carried by an AGV 14 may pass over it. When the container is in position over the supports 50, they raise up, thus transferring the container from the AGV thereto. In order to retrieve the container from the supports 50, a reverse sequence of actions is performed.

According to the modifications described with reference to FIGS. 8 and 9, each floor may be provided with a small number of AGVs 14 relative to the number of bays 24 therein, each AGV occupying a bay when not in use, for example a corner. Since the containers are stored in a position permitting passage thereunder by an AGV 14, when an AGV is requested to receive a container thereon from a marine vessel, it may travel to the necessary location without being impeded by containers stored bays 24 in the path of the AGV.

The control system 16 is designed to direct the operation of the storage system 10. As such, it is configured to communicate with the structure 12 and the AGVs 14. As illustrated in FIG. 7, it may comprise software running on a CPU 36, one or more data presentation units 38, and one or more user input devices 40. The data presentation units 38 may comprise one or more monitors, LEDs, speakers, audible alarms, and/or any other appropriate device. The user input devices 40 may comprise one or more keyboards, touch-sensitive displays, computer mouses, microphones (for example working in conjunction with voice-recognition software), and/or any other appropriate device.

In addition, the control system 16 may be configured to store information, for example regarding identification of containers, associations between each container and a respective AGV 14, location of each AGV (and thus the container it is carrying), identification of a truck meant to retrieve it, historical data, etc. This information may be stored and managed by the CPU 36, or by an optional auxiliary CPU 42, which may further comprise or be associated with internal or external storage means 44. (Herein the presently disclosed subject matter, references to the CPU 36 may implicitly apply, in whole or in part, to the auxiliary CPU 42 and/or storage means 44, mutatis mutandis.)

The entire control system 16 may be provided near the structure 12, for example situated such that an operator thereof has an unobstructed view thereof, and may also have an unobstructed view of at least part of a path between the dock and the structure.

Alternatively, at least portions of the control system 16 may be located at a location remote from the structure 12. For example, the CPU 36 may be constituted by a server in a remote data center running an appropriate computer program. In such a case, appropriate means may be provided in the vicinity of the structure 12 and/or the marine shipping yard for transmitting/receiving information thereto/therefrom. In addition, a “dumb terminal”, comprising the data presentation units 38 and the user input devices 40, may be provided in the vicinity of the structure 12, thereby enabling an operator to access the CPU 36 while observing the operation of the rest of the storage system 10.

In addition to the above, the storage system 10 may comprise any necessary elements (not illustrated) to facilitate its operation, for example as described below. These elements may include, but are not limited to, GPS sensors, RFID (radio frequency identification) tags and reader(s), manual override and/or failsafe means, manual and/or automatic emergency shutoff means, charging/refueling stations for AGVs 14 (as appropriate based on the type of AGV used), etc.

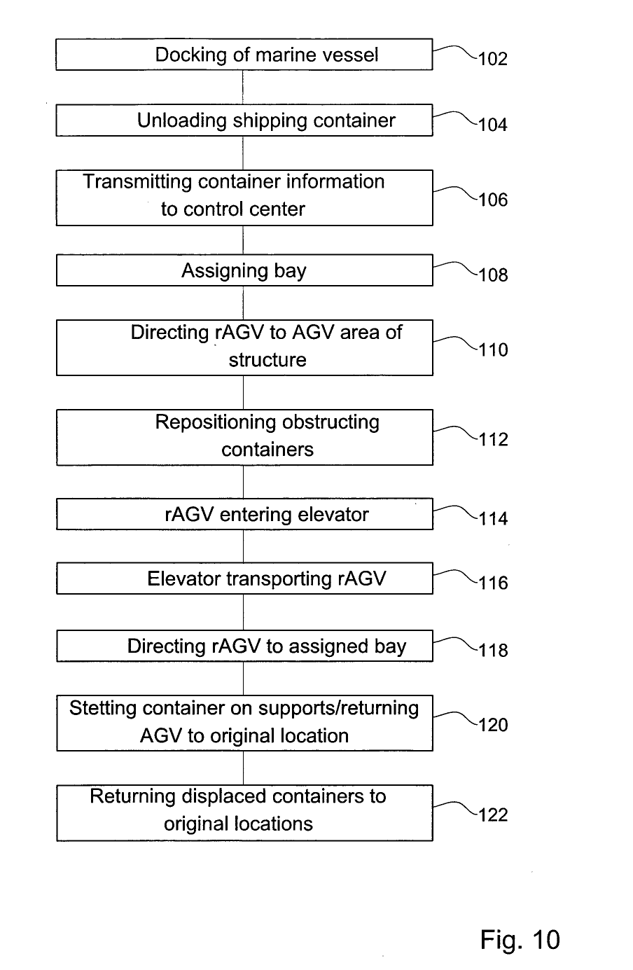

Unloading and storage, using the storage system 10, of a container from a marine vessel proceeds according to a method 100 described below and illustrated in FIG. 10. According to the method 100, the following steps may occur when transferring a shipping container from a marine vessel for storage:
As indicated at 102, a marine vessel docks at a marine shipping dock.
As indicated at 104, a shipping container is unloaded from the vessel, for example via crane, and is placed on an AGV 14. The AGV 14 which receives the container is hereafter referred to as a “receiving AGV” (rAGV) 14a. According to the example illustrated in FIGS. 4A and 4B, the rAGV 14a may receive the container on the balcony 46.
As indicated at 106, optionally, information relating to container identification may be transmitted to the control system 16, and processed/stored by the CPU 36.
As indicated at 108, the control system 16 assigns a bay 24 of the structure 12 to the rAGV 14a.
As indicated at 110, the control system 16 directs the rAGV 14a to the elevator 22.
If necessary, as indicated at 112, the control system 16 repositions any container obstructing the path between the rAGV 14a and the assigned bay. This may be done by temporarily moving the obstructing container to an unoccupied bay. Alternatively, this may be done by temporarily removing the obstructing container from the level.

Alternatively, this may be done by moving the obstructing container to the assigned bay, and reassigning the bay vacated by the (formerly) obstructing AGV to the rAGV 14a. According to the examples illustrated in FIGS. 3C and 3D, the obstructing container may be temporarily repositioned to the elevator.
If necessary, as indicated at 114, the rAGV 14a enters the elevator 22. It will be appreciated that this step may be skipped, for example, if the container is delivered to the balcony 46 and the assigned bay 24 is on the same floor thereof.
If necessary, as indicated at 116, the elevator transports the rAGV 14a to the storage level 18a of the structure 12 containing the assigned bay 24.
As indicated at 118, the rAGV 14a is directed to the assigned bay.
According to the modifications described with reference to FIGS. 7 and 8, as illustrated at 120, the container may be set down on the supports 50, 58, and the AGV 14 may return to its original location.
If necessary, as indicated at 122, any AGV which was temporarily displaced is returned to its original location.

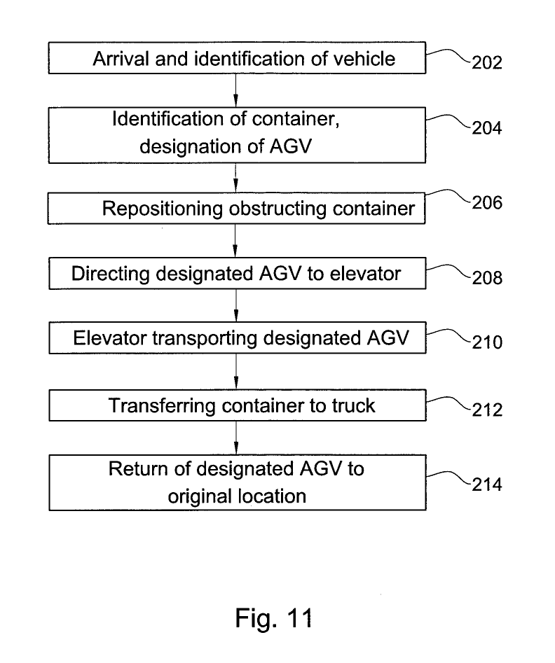

Retrieval, using the storage system 10, of a container from the structure 12 proceeds according to a method 200 described below and illustrated in FIG. 11. According to the method 200, the following steps may occur when transferring a shipping container from storage within the structure 12 to a vehicle, such as a truck or a train, for shipment toward its final destination:
As indicated at 202, a vehicle arrives at the storage system 10 and identifies itself.
As indicated at 204, based on the identification of the vehicle, the control system 16 identifies the appropriate container to transfer to the truck, and designates an AGV to retrieve it.
If necessary, as indicated at 206, the control system 16 repositions any container obstructing the path between the designated AGV 14 and the elevator. This may be done by temporarily moving the obstructing container to an unoccupied bay. Alternatively, this may be done by temporarily removing the obstructing container from the level. Alternatively, this may be done by assigning the obstructing container to a new bay which does not obstruct the path between the designated AGV 14 and the elevator, and moving the obstructing container to it. According to the examples illustrated in FIGS. 3C and 3D, the obstructing container may be temporarily repositioned to the elevator.
As indicated at 208, the control center 16 directs the designated AGV 14 to the elevator 22.
As indicated at 210, the elevator transports the designated AGV 14 to the transfer level 18b.
As indicated at 212, the hoist 26 transfers the container from the designated AGV 14 to the truck, which then may depart the storage system 10 with the container.
As indicated at 214, the designated AGV is then returned to its original location.

It will be appreciated that the above steps may be performed in any appropriate order.

It will further be appreciated that operations of the control center 16 as described herein could be autonomous actions thereof, or operations at least partially performed by an operator.

It will be still further appreciated that the control system 16 may perform any necessary internal operations, such as updating databases regarding locations of the contains/rAGVs 14, keeping track of AGVs 14 available to receive a new container, selecting an AGV to receive a container, etc.

It will be still further appreciated that implicit in the above-described methods are unloading, storage, and retrieval of a plurality of containers. For this purpose several structures 12 may be provided.

In addition, a method of transferring a container from a marine vessel to a truck, which includes the steps described above with reference to FIGS. 10 and 11, is provided.

Use of the storage system 10 disclosed herein, for example by the methods described herein, may facilitate stacking of containers to any desired height, irrespective of the strength thereof, provided that the structure is constructed accordingly. In addition, it may simplify and lower the amount of time necessary to retrieve a stored container. This may contribute to less time spent by vehicles waiting to receive a container.

Those skilled in the art to which this invention pertains will readily appreciate that numerous changes, variations and modifications can be made without departing from the scope of the invention mutatis mutandis.

1-46. (canceled)

48. A method of transferring a plurality of containers to storage, the method comprising:
providing at least one multi-level structure with an elevator configured to receive and transport one or more containers thereupon and being configured to ascend and descend to a predetermined level, each of said levels comprising a plurality of bays being sized to receive and store therein one of said containers;
providing a plurality of unmanned autonomous guided vehicles (AGV) configured to perform front/back and sideways movements and to receive a container thereupon;
receiving each of said containers on a receiving AGV (rAGV) of said AGVs; and
positioning said rAGV with the container received thereby in a target bay on a target level of said structure.

49. The method according to claim 48, wherein said at least one multi-level structure further comprises a balcony, said receiving each of said containers taking place on said balcony.

50. The method according to claim 48, wherein each of said plurality of bays comprises an arrangement for supporting a container.

51. The method according to claim 50, wherein each of said AGVs is configured to alter a height thereof between a raised height and a lowered height, and wherein said arrangement comprises a plurality of supports, each having a height which is higher than said lowered height of said AGVs, and lower than said raised height of said AGVs.

52. The method according to claim 50, wherein said arrangement comprises a plurality of supports, each of the plurality of support configured for having a height thereof adjusted between a raised height and a lowered height, said raised height of each support being higher than the height of said AGVs, and said lowered height of each support being lower than the height of said AGVs.

53. The method according to claim 50, wherein each of said AGVs is configured to alter a height thereof between a raised height and a lowered height, said method further comprising providing a plurality of movable supports configured for supporting a container, each of said movable supports having a height which is higher than said lowered height of said AGVs, and lower than said raised height of said AGVs.

54. The method according to claim 48, wherein said containers are received from a marine vessel.

55. The method according to claim 54, wherein said containers are transferred from said marine vessel to said rAGV using a crane.

56. The method according to claim 55, wherein at least some of said containers are transferred from said marine vessel to an intermediate vehicle, and from said intermediate vehicle to said rAGV.

57. A method of transferring a plurality of containers from storage, the method comprising:
providing at least one multi-level structure with an elevator configured to receive and transport one or more containers thereupon and being configured to ascend and descend to a predetermined level, each of said levels comprising a plurality of bays being sized to receive and store therein one of said containers, at least one of said levels constituting a transfer level, at least some of said bays having containers stored therein;
providing a plurality of unmanned autonomous guided vehicles (AGV), each containing configured to perform front/back and sideways movements and to receive a container thereupon;
identifying a container-to-be-transferred;
directing a designated AGV to retrieve the container-to-be-transferred from said bay and move it toward a vehicle; and
transferring said container-to-be-transferred to said vehicle.

58. The method according to claim 57, wherein each of said plurality of bays comprises an arrangement for supporting a container.

59. The method according to 58, wherein each of said AGVs is configured to alter a height thereof between a raised height and a lowered height, and wherein said arrangement comprises a plurality of supports, each having a height which is higher than said lowered height of said AGVs, and lower than said raised height of said AGVs.

60. The method according to claim 58, wherein said arrangement comprises a plurality of supports, each configured for having its height adjusted between a raised height and a lowered height, said raised height of each support being higher than the height of said AGVs, and said lowered height of each support being lower than the height of said AGVs.

61. The method according to claim 58, wherein each of said AGVs is configured to alter a height thereof between a raised height and a lowered height, said method further comprising providing a plurality of movable supports configured for supporting a container, each of said movable supports having a height which is higher than said lowered height of said AGVs, and lower than said raised height of said AGVs.

62. The method according to claim 57, wherein said vehicle is a marine vessel.

63. A storage system, comprising:
at least one multi-level structure with an elevator configured to receive and transport one or more containers thereupon and being configured to ascend and descend to a predetermined level, each of said levels comprising a plurality of bays being sized to receive and store therein one of said containers;
a plurality of unmanned autonomous guided vehicles (AGV) configured to perform front/back and sideways movements and to receive a container thereupon; and
a control system configured to direct operation of the AGVs to receive containers, bring containers to a target bay for storage, and retrieve stored containers.

64. The system according to claim 63, wherein each of said plurality of bays comprises an arrangement for supporting a container.

65. The system according to claim 64, wherein each of said AGVs is configured to alter a height thereof between a raised height and a lowered height, and wherein said arrangement comprises a plurality of supports, each having a height which is higher than said lowered height of said AGVs, and lower than said raised height of said AGVs.

66. The system according to claim 64, wherein said arrangement comprises a plurality of supports, each configured for having its height adjusted between a raised height and a lowered height, said raised height of each support being higher than the height of said AGVs, and said lowered height of each support being lower than the height of said AGVs.

67. The system according to claim 64, wherein each of said AGVs is configured to alter a height thereof between a raised height and a lowered height, said system further comprising a plurality of movable supports configured for supporting a container, each of said movable supports having a height which is higher than said lowered height of said AGVs, and lower than said raised height of said AGVs.
